(19) United States
(12) Patent Application Publication
(10) Pub. No.: US 2024/0048635 A1
(43) Pub. Date: Feb. 8, 2024

(54) METHOD AND SYSTEM FOR TRANSFORMING AND INTEGRATING MOBILE DEVICE SHOPPING INTERFACES ACROSS MULTIPLE SHOPPING VENUES AND CARRIERS

(71) Applicant: MINIME-LABS GLOBAL, INC., Austin, TX (US)

(72) Inventor: Constantinos Demetriou, Limassol (CY)

(21) Appl. No.: 18/376,791

(22) Filed: Oct. 4, 2023

Related U.S. Application Data
(63) Continuation-in-part of application No. 18/215,143, filed on Jun. 27, 2023.
Application No. 18/215,143 is a continuation-in-part of application No. 17/674,119, filed on Feb. 17, 2022, now abandoned.
Application No. 17/674,119 is a continuation of application No. 16/726,806, filed on Dec. 24, 2019, now abandoned.
Application No. 16/726,806 is a continuation of application No. 16/281,236, filed on Feb. 21, 2019, now abandoned.
(60) Provisional application No. 62/633,509, filed on Feb. 21, 2018.

(51) Int. Cl. H04L 67/52; G06Q 50/14; G06Q 50/30; H04L 67/50

(52) U.S. Cl. CPC H04L 67/52; G06Q 50/14; G06Q 50/30; H04L 67/535

(57) ABSTRACT

A method to provide integrated and personalized services on a personalized digital interface involving a location-aware digital engagement platform. The concept includes the system capable of developing an awareness of user location. The method includes the steps of receiving a network connection request from a user device for providing network services, sending a prompt to the user device to either answer personalized questions or share a user profile that is stored in a private memory space of a user, receiving user information including answers to the personalized questions and/or the shared user profile, creating personalized features for the user based on location of the networking device and received user information to generate personalized digital interface having links to web pages, and enabling a push service to present the personalized digital interface on the user device.

### RELATED APPLICATIONS

The present disclosure is a Continuation-In-Part (CIP) of U.S. Non-Provisional Application No. 18/215,143, filed Jun. 27, 2023; which is a Continuation-in-Part (CIP) of U.S. Non-Provisional application Ser. No. No. 17/674,119, filed Feb. 17, 2022 (now abandoned); which is a Continuation of U.S. Non-Provisional Patent application Ser. No. 16/726,806, filed on Dec. 24, 2019 (now abandoned); which is a Continuation of U.S. Non-Provisional patent application Ser. No. 16/281,236, filed on Feb. 21, 2019 (now abandoned); which claims the benefit of U.S. Provisional Patent Application No. 62/633,509, filed on Feb. 21, 2018; all of which are incorporated herein in their entirety by reference.

### BACKGROUND

### Technical Field

The present disclosure relates to the field of methods and systems for shopping interfaces across multiple shopping venues and carriers, and in particular, to methods and systems for transforming and integrating mobile device shopping interfaces across multiple shopping venues and carriers.

### Description of the Related Art

Currently, it is noticed that a user must download multiple applications on a user device to access multiple services that have the same functionalities but are merely customized based on services offered by a vendor. For example, in case of the user travelling to a different place, there might be multiple applications from different travel companies offering several similar functionalities and few specific features. The user has to download multiple applications. Further, these applications might be designed to a set of service to user and if user need other services, he/she might have to download another application. For example, the user planning a travel might need an application for booking tickets, a separate application for checking amenities at the airport, a separate application for booking a cab, a separate application for managing the stay at a hotel, a separate application to get information about the local places, and a separate application for shopping. Using multiple custom application to perform “specific but the same” functions cause inconvenience to the user, such as a user has to invest a lot of time to get familiar with the interfaces of each application which are generalized interface for the majority of the population. Additionally, downloading multiple applications for such multiple services has various other disadvantages, such as high data usage while downloading the multiple applications, high storage space consumption on the user device, frequent updating, and additional costs involved in buying individual subscriptions of the multiple application. Some of these issues are partially addressed by the existing system described below:

U.S. Pat. No. 9,927,954 B2 discloses dynamic interface to present customized information contextually in relation to access to a property. The patent '954 discloses that a method for presenting customized information on a display of the wireless mobile device. The customized information may be associated with graphic images and/or icons that may represent different information as a function of time, location, type of activity, type of event, anonymized trend data, push notifications, and electronic messages. However, the customization in patent '954 is not user-centric but data-centric and the customized information is displayed on the display via an APP that is installed on the user device and is downloaded from application stores corresponding to the operating system of the wireless mobile device. Thus, the patent '954 fails to address the one or more issues of the prior arts, such as high data consumption, storage space consumption, and frequent updates, as mentioned above.

U.S. Pat. No. 9,087,344 B2 discloses systems and methods for accessing travel services using a portable electronic device. The patent '344 discloses integrating travel services in a single application available to a portable electronic device. Further, the patent '344 discloses that using such single application, the user can access and control travel services before arriving at an initial location of travel, upon arriving at the initial location of travel, during travel, and after travel. However, the integration of the one or more similar service in patent '344 is on the single application that is installed on the portable electronic device. Thus, the patent '344 also fails to address the one or more issues of the prior arts, such as high data consumption, storage space consumption, and frequent updates, as mentioned above.

Thus, the prior art references together disclose an application that is installed on the user device for providing multiple services to the user via a customizable interface, however, such customizable interface is not user-centric and since the application is installed on the user device, the prior art references fail to address the issues of the associated with data, storage, and frequent updates, as mentioned above. Additionally, to provide customized information to the user that is user-centric rather than data-centric, the one or more existing technologies would need to monitor the user's activities to get the user's personal data (e.g., user's name, age, preferences, location, address, images or the like) for providing such personalized services and offers. Such sharing of personal data between the user and a server associated with the prior art references can lead to personal data leakage that can prove to be devasting for the user on both social and financial grounds.

Therefore, there is a need for an improved system and method to provide integrated and personalized services while protecting the personal data of the user to overcome the above-mentioned drawbacks of the known technologies.

### BRIEF SUMMARY

One or more embodiments are directed to a system and method to provide to transform and integrate mobile device shopping interfaces across multiple shopping venues and carriers, irrespective of the particular type of interface in use. Such devices may include, for example, a smart phone screen, including augmented reality glasses, flexible displays, different headsets, or other means for displaying information to the mobile user.

An embodiment of the present disclosure discloses a system to provide integrated and personalized services on the integrated mobile device. The system includes one or more Network Service Provider (NSP) modules to receive a network connection request from a user device for providing network services. The network connection request is received through a networking device associated with an establishment. The user device includes, without any limitation, a mobile phone, a laptop, a tablet, a Personal Digital Assistant (PDA), eyeglasses, a smartwatch. Further, the one or more NSP modules are associated with a Wireless Fidelity (Wi-Fi), a mobile network, a Local Area Network, an Internet, an Intranet, or a combination thereof. Furthermore, the networking device is associated with an establishment including, without any limitation, a home, a bank, a shop, an office, a restaurant, a theatre, a hospital, a hotel, a monument, a street, a sports stadium, an airport, and a flight.

A fundamental aspect of the present disclosure involves a location-aware digital engagement platform. The concept includes the system capable of developing an awareness of where is the user. Based on the location information, the system provides information responsive to the user's location. By using principles of location awareness for the digital platform, the user experience is a much more relevant and in correspondence with items and actions in of interest in the location that the user occupies.

All this input is relative to the user's position and the documented interests of the user, as well as the local resources relevant to both the position and the users interested, all without real-time and intentional control input by the user.

The subject matter of the present disclosure provides an internal tracking of items of interest to the user. The system here disclosed gives the opportunity to the user to receive and select inputs that pertain to the user's interest and the user's location. All information from present digital platform may be customized by the user to maximize the experience as the user moves from location to location. The platform learns the user's preferences and allows the user to engage in actions he desires as prompted by the platform's presentation.

In any location, there are buttons or controls on the digital platform relating to restaurants, specialty shops, and other venues of interest to the user. In the digital platform's preference engine the user may determine which of the items appear under the different categories presented or selected by the user. Thus, the digital platform differs from a questionnaire or form that may be presented to the user. And the subject matter of the present invention enables a cumulative process of learning as the user progresses in his movements across locations. Thus, by taking particular actions in a particular venue, the digital platform of the present disclosure learns from the actions that the user takes to create profiles of interest tailored to the particular user.

In some embodiments, the system includes a data collection module to send a prompt to the user device in furtherance to receiving the network connection request. Alternatively, or additionally, the data collection module is triggered to send a prompt to the user device when the one or more NSP modules detect the user device within a pre-defined range from the networking device. The prompt allows the user to share answer to some personalized questions or share part or full user profile maintained at the user device with the establishment. The user profile may be created and maintained based on data fed by the user and user activity data collected from the user device. In some embodiments, the user profile is maintained in form of a knowledge graph having one or more nodes based on a set of personalized questions and corresponding user responses.

In some embodiments, the data collection module also receives user information in response to the user selection of an option included in the sent prompt. The user information includes answers to the personalized questions, the shared user profile, or a combination thereof. In some embodiments, the system includes an Artificial Intelligence (AI) module to create one or more personalized features for the user based on location of the networking device and the received user information. The created one or more personalized features and information includes information about the user location data, advertisements of entities associated with the establishment, offers and rewards associated with the entities associated with the establishment, payment gateway options, menus, event information, location alerts, and feedbacks associated with one or more services available to the user from the establishment associated with the networking device. In some embodiments, the system includes an integrating module to generate a personalized digital interface, such as an interface that may comprise links to one or more webpages based on the created one or more personalized features for the user. In some embodiments, the system includes a personalized digital interface push module to enable a push service to present the personalized digital interface on the user device.

In some embodiments, the data collection module further provides the user information to establishment (e.g. a merchant device), such that the establishment can provide personalized offers and services to the user. The personalized services include, without any limitation, a food menu based on user preferences, apparel based on user's size, a room with a user preference temperature, and products based on the user profile.

An embodiment of the present disclosure discloses a method to provide integrated and personalized services on the personalized digital interface. The method includes the steps of receiving a network connection request from a user device for providing network services. The network connection request may be received through a networking device associated with an establishment. In furtherance to receiving the network connection request, the method includes the steps of sending a prompt to the user device for sharing user information. The prompt may be associated with the selection of an option to share answer personalized questions, or an option to share a user profile that is stored in a private memory space of a user, or both. Alternatively, or additionally, the method may include the steps of sending a prompt to the user device when the user device is detected within a pre-defined range from the networking device.

In response to the user selection of the sent prompt, the method includes the steps of receiving user information from the user device. The user information may include answers to the personalized questions, the shared user profile, or a combination thereof. In some embodiments, the method includes the steps of creating one or more personalized features for the user. Upon creating the one or more personalized features, the method includes the steps of generating a personalized personalized digital interface, such as a personalized digital interface, having links to one or more web pages. Thereafter, the method includes the steps of enabling a push service to present the personalized digital interface on the user device.

In some embodiments of the present disclosure, the method includes the steps of providing the user information to an establishment associated with the networking device (e.g., a merchant device), such that the establishment can provide personalized offers and services to the user. The personalized services may, without any limitation, include a food menu based on user preferences, apparels based on user's size, a room with a user preference temperature, and products based on the user profile.

The features and advantages of the subject matter here will become more apparent in light of the following detailed description of selected embodiments, as illustrated in the accompanying FIGURES. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

The present subject matter will now be described in detail with reference to the drawings, which are provided as illustrative examples of the subject matter so as to enable those skilled in the art to practice the subject matter. Notably, the FIGURES and examples are not meant to limit the scope of the present subject matter to a single embodiment, but other embodiments are possible by way of interchange of some or all of the described or illustrated elements and, further, wherein:

FIG. 1 illustrates an exemplary environment of an integrated services system to provide integrated and personalized services, in accordance with an embodiment of the present disclosure;

FIG. 2 illustrates a block diagram for the system to provide integrated and personalized services on the personalized digital interface, in accordance with an embodiment of the present disclosure;

FIG. 3A illustrates an exemplary user device interface for registering a user, in accordance with an embodiment of the present disclosure;

FIG. 3B illustrates an exemplary user device interface for creating a user profile, in accordance with an embodiment of the present disclosure;

FIG. 4 illustrates a knowledge graph associated with the user profile, in accordance with an embodiment of the present disclosure;

FIGS. 5A-5C illustrates exemplary user device interfaces when the user is connected to an airport departure Wireless-Fidelity (Wi-Fi) network, in accordance with an embodiment of the present disclosure;

FIG. 6 illustrates an exemplary user device interface when the user is connected to an airport arrival Wi-Fi network, in accordance with an embodiment of the present disclosure;

FIG. 7A illustrates an exemplary user device interface when the user is connected to a hotel network, in accordance with an embodiment of the present disclosure;

FIG. 7B illustrates an exemplary merchant device interface when the user is connected to a hotel network, in accordance with an embodiment of the present disclosure;

FIGS. 8A-8B illustrates exemplary user device interfaces when the user is connected to a mall network, in accordance with an embodiment of the present disclosure;

FIG. 8C illustrates an example illustrates exemplary merchant device interfaces when the user is connected to the mall network, in accordance with an embodiment of the present disclosure;

FIG. 9 illustrates a flowchart of a method to provide integrated and personalized services on the PERSONALIZED DIGITAL INTERFACE, in accordance with an embodiment of the present disclosure; and

FIG. 10 illustrates an exemplary computer system in which or with which embodiment of the present disclosure may be utilized.

Other features of embodiments of the present disclosure will be apparent from accompanying drawings and detailed description that follows.

### DETAILED DESCRIPTION

The detailed description set forth below in connection with the appended drawings is intended as a description of exemplary embodiments in which the presently disclosed disclosure can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed disclosure. However, it will be apparent to those skilled in the art that the presently disclosed disclosure may be practiced without these specific details. In some instances, well-known structures and devices are shown in block diagram form in order to avoid obscuring the concepts of the presently disclosed disclosure.

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and/or firmware.

Embodiments of the present disclosure may be provided as a computer program product, which may include a non-transitory, machine-readable storage medium tangibly embodying thereon instructions, which may be used to program the computer (or other electronic devices) to perform a process. The machine-readable medium may include, but is not limited to, fixed (hard) drives, semiconductor memories, such as Read Only Memories (ROMs), Programmable Read-Only Memories (PROMs), Random Access Memories (RAMs), Erasable PROMs (EPROMs), Electrically Erasable PROMs (EEPROMs), flash memory or other types of media/machine-readable medium suitable for storing electronic instructions (e.g., computer programming code, such as software or firmware).

Various methods described herein may be practiced by combining one or more non-transitory, machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection. Based on the disclosure provided herein, one of ordinary skill in the art will appreciate a variety of ways in which connection or coupling exists in accordance with the aforementioned definition.

Further, the term “module” may be software or hardware particularly programmed to receive an input, perform one or more processes using the input, and provide an output. The input, output, and processes performed by various modules will be apparent to one skilled in the art based on the present disclosure.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

It will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular name.

Embodiments of the present disclosure relate to a system and method to provide integrated and personalized services on a personalized digital interface. The system includes one or more Network Service Provider (NSP) modules to receive a network connection request, through a networking device, from a user device for providing network services. Further, the system includes a data collection module to send, in furtherance to receiving the network connection request, a prompt to the user device to select at least one of answer personalized questions and share a user profile that is stored in a private memory space of a user. The system also includes receiving, in response to user selection of the sent prompt, user information including at least one of answers to the personalized questions and the shared user profile. Further, the system includes an Artificial Intelligence (AI) module to create one or more personalized features, associated with one or more services, for the user based on location of the networking device and the received user information. Furthermore, the system includes an integrating module to generate a personalized digital interface comprising links to one or more web pages, based on the created one or more personalized features for the user. Additionally, the system includes a personalized digital interface push module to enable a push service to present the personalized digital interface on the user device.

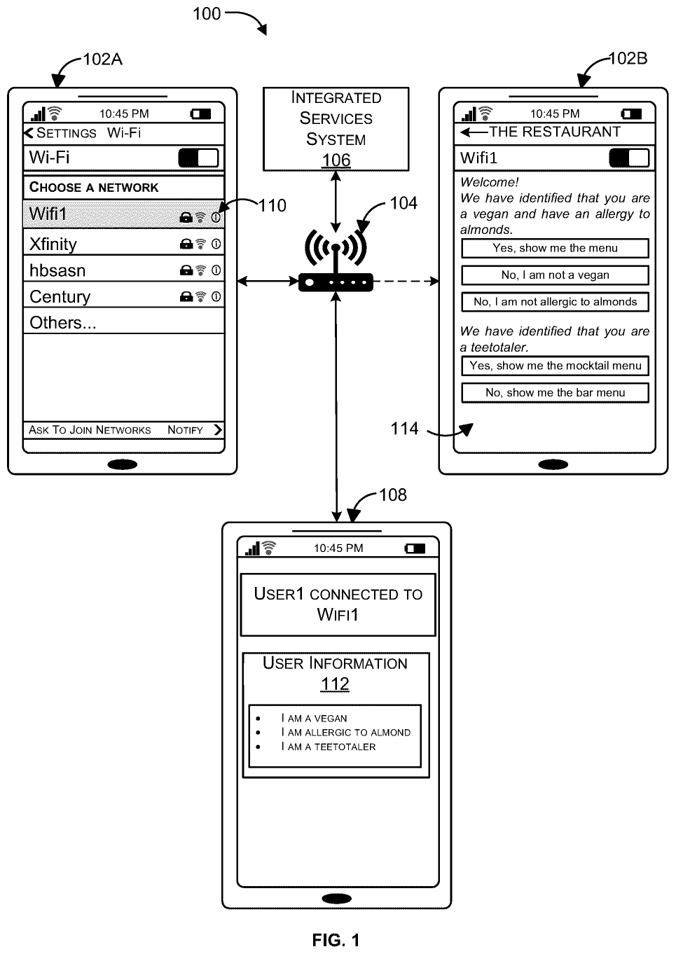

FIG. 1 illustrates an exemplary environment 100 of an integrated services system to provide integrated and personalized services on personalized digital interface, in accordance with an embodiment of the present disclosure. The personalized digital interface may correspond to a Hyper-Text Mark-up Language (HTML) based website that may operate similar to an application that may be installed on a user device 102A. The user device 102A may, without any limitation, include an electronic device, such as a mobile phone, a laptop, a tablet, and a Personal Digital Assistant (PDA), eyeglasses, a smartwatch, a Virtual Reality (VR) device, an Augmented Reality (AR) device, and a Mixed Reality (MR) device that can connect to a networking device 104 to access network services. In an embodiment of the present disclosure, the networking device 104 may be associated with Wireless-Fidelity (Wi-Fi), a mobile network, a Local Area Network, an Internet, and an Intranet. The networking device 104 may be installed at an establishment, such as a home, a bank, a shop, an office, a restaurant, a theater, a hospital, a hotel a monument, a street, a sports stadium, an airport, and a flight. In some embodiments, the networking device 104 may be communicatively coupled to an integrated services system 106 (hereinafter termed as system 106).

When the user attempts to connect with the network device 104, the system 106 may control a connection layer of the networking device 104 to allow connection of the user device 102A with the networking device 104 to provide network services and direct the user device 102A details to an authentication layer. The authentication layer may send a prompt on the user device 102A that is associated with a request for sharing user information for providing personalized service to the user. In one instance, if the user does not share the user information, then the system 106 may render a generalized interface on the user device 102 with general services and offers. In another instance, if the user shares the user information, then the system 106 may provide a personalized interface to the user associated with personalized services and offers.

In some embodiments, such personalized services may be provided by the merchant associated with a merchant device 108. For providing personalized services through the merchant, the network device 104 may send the received user information 112 to the merchant device 108. The personalized services may, without any limitation, include a food menu based on user preferences, apparel based on user's size, a room with a user preference temperature, and products based on the user profile. For example, the user information 112 may correspond to ‘I am a Vegan’, ‘I am allergic to almonds’, and ‘I am a teetotaler’. In response to receiving the user information 112, the merchant may send personalized services and offers to the client, as shown by the client device 102B. For example, the merchant may identify that the user is vegan who is a teetotaler having allergies to almonds and may present the user with one or more options to view a menu having only vegetarian and almond-free dishes, and/or a mocktail menu without alcohol. In another scenario, such personalized services may automatically be presented to the user through the integrated services system 106, as would be discussed in detail in the following paragraphs.

A fundamental aspect of the present disclosure involves a location-aware digital engagement platform. The concept includes the system capable of developing an awareness of where it the user. Based on the location information, the system provides information responsive to the user's location of the user. By using principles of location awareness for the digital platform, the user experience is a much more relevant and in correspondence with items and actions in of interest in the location that the user occupies.

All this input is relative to the user's position and the documented interests of the user, as well as the local resources relevant to both the position and the users interested, all without real-time and intentional control input by the user.

The subject matter of the present disclosure provides an internal tracking of items of interest to the user. The system here disclosed gives the opportunity to the user to receive and select inputs that pertain to the user's interest and the lee users location. All information from present digital platform may be customized by the user to maximize the experience as the user moves from location to location. The platform learns the user's preferences and allows the user to engage in actions he desires as prompted by the platform's presentation.

In any location, there are buttons or controls on the digital platform relating to restaurants, specialty shops, and other venues of interest to the user. In the digital platform's preference engine the user may determine which of the items appear under the different categories presented or selected by the user. Thus, the digital platform differs from a questionnaire or form that may be presented to the user. And the subject matter of the present invention enables a cumulative process of learning as the user progresses in his movements across locations. Thus, by taking particular actions in a particular venue, the digital platform of the present disclosure learns from the actions that the user takes to create profiles of interest tailored to the particular user.

In some embodiments, the system includes a data collection module to send a prompt to the user device in furtherance to receiving the network connection request. Alternatively, or additionally, the data collection module is triggered to send a prompt to the user device when the one or more NSP modules detect the user device within a pre-defined range from

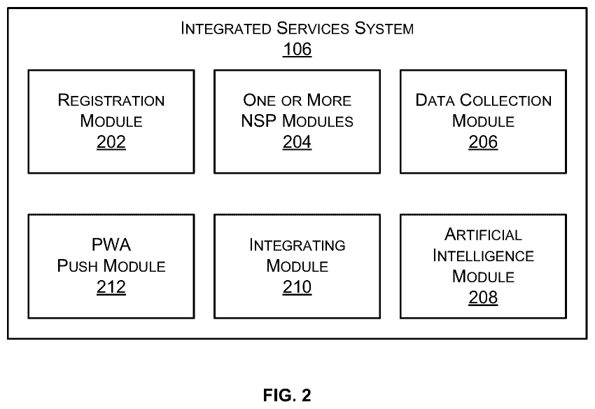

FIG. 2 illustrates a block diagram for the system 106 to provide integrated and personalized services on the personalized digital interface, in accordance with an embodiment of the present disclosure. In an embodiment of the present disclosure, the system 106 may include a registration module 202, one or more Network Service Provider (NSP) modules 204, a data collection module 206, an Artificial Intelligence (AI) module 208, an integrating module 210, and a personalized digital interface push module 212.

In an embodiment of the present disclosure, the registration module 202 may register a user for personalized digital interface access and collect willingness of the user to receive a personalized digital interface. In order to register the user in the personalized digital interface, the registration module 202 may request the user to provide a username and a password. Additionally, or alternatively, the user may also register via one or more linked accounts, such as social media accounts. After the successful registration of the user in the personalized digital interface, the registration module 202 may facilitate the user to create a user profile. The user profile may be created and maintained based on data fed by the user and user activity data collected by the user device 102. For facilitating the user to create the user profile, the registration module 202 may provide a plurality of questionnaires to the user, such that the user may respond to the provided questionnaires and store the response data in a private memory space of the user. The private memory space of the user may include the local memory of the user device or a cloud storage of the user. In some embodiments, the user profile may be maintained in form of a knowledge graph having one or more nodes based on a set of personalized questions and corresponding user responses.

In an embodiment of the present disclosure, the one or more NSP modules 204 may receive a network connection request from the user device 102 for providing network services. The one or more NSP modules 204 may be communicatively coupled to the networking device 104 to receive the network connection request. Alternatively, or additionally, the one or more NSP module 204 may automatically detect the user device 102 within a pre-defined range from the networking device 104 to automatically receive the network connection request.

In an embodiment of the present disclosure, the data collection module 206 may send a prompt to the user device in response to receiving the network connection request. The prompt may be associated with options to sharing user information via a) answering personalized questions, b) sharing the user profile that is stored in the private memory space of the user, or a combination thereof. The user may select one or both ways of sharing the user information via answering the personalized questions and/or sharing the user profile. Based on such user selections, the data collection module 206 may receive the corresponding user information from the user device 102.

In an embodiment of the present disclosure, the AI module 208 may create one or more personalized features for the user based on location of the networking device 104 and the received user information. The one or more personalized features and information may, without any limitation, include information about the user location data, advertisements of entities in proximity, offers and rewards associated with the proximate entities, payment gateways, menus, events, location alerts, feedbacks, interactive elements, 3D visual elements, and virtual objects associated with the networking device.

In an embodiment of the present disclosure, the integrating module 210 may generate a personalized digital interface. The integrating module 210 may determine one or more links to one or more webpages based on the created one or more personalized features for the user. Such determines one or more links may be integrated to form the personalized digital interface to be presented on the user device 102. In an embodiment of the present disclosure, the personalized digital interface push module 212 may enable a push service to present the personalized digital interface on the user device 102. The personalized digital interface push module 212 may utilize the authentication layer of the networking device 104 to enable the push service on the user device 102.

To ensure that the user data is shared only between the user device and approved establishments, instance of one or more modules such as the data collection module 206, the personalized digital interface push module 212, integrating module 210, and artificial intelligence module 208 may be executed by the computing device of the establishment. The user will be in control of the personal data and even the integrated services system may not have access to most of the user information.

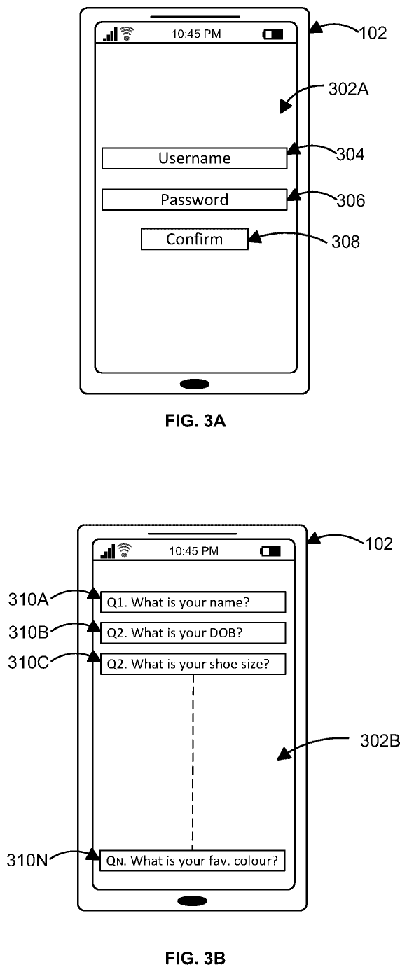

FIG. 3A illustrates an exemplary user device interface 302A for registering a user, in accordance with an embodiment of the present disclosure. FIG. 3B illustrates an exemplary user device interface 302B for creating a user profile, in accordance with an embodiment of the present disclosure. For the sake of brevity of explanation, FIGS. 3A and 3B have been explained together. In an embodiment of the present disclosure, the registration module 202 facilitates the registration of the user in the personalized digital interface. In order to facilitate registration, the registration module 202 renders the user device interface 302A having an option 304 to enter a username, an option 306 to enter a password 306, and an option 308 to confirm the inputs. Further, based on the received username and the password, the registration module 202 may register the user and create a User ID associated with the received username and a log-in password associated with the received password.

Upon creating the user ID, the registration module 202 may facilitate the user to create the user profile having the user's personal information. In order to facilitate the user to create the user profile, the registration module 202 may render a user device interface 302B having a plurality of personal questionnaires 310A, 310B, 310C . . . , 310N (hereinafter termed as questionnaires 310). For example, the questionnaires may, without any limitation, include ‘what is your name?’, ‘what is Date of Birth?’, ‘What is your shoe size?’, and ‘What is your favorite color?’. In some embodiments, the user may provide answers to the provided questionnaires 310 to create the user profile having the personal information of the user. Further, the created user profile may be stored in a local memory of the user device and/or a cloud memory associated with the user.

It should be noted that the created user profile may not be shared with any one of the system 100, the server, a centralized storage, an establishment's storage, or the personalized digital interface provider. Further, the created user profile may be created to have a self-destruction ability after a pre-defined time interval of sharing with any entity such as the ones described above.

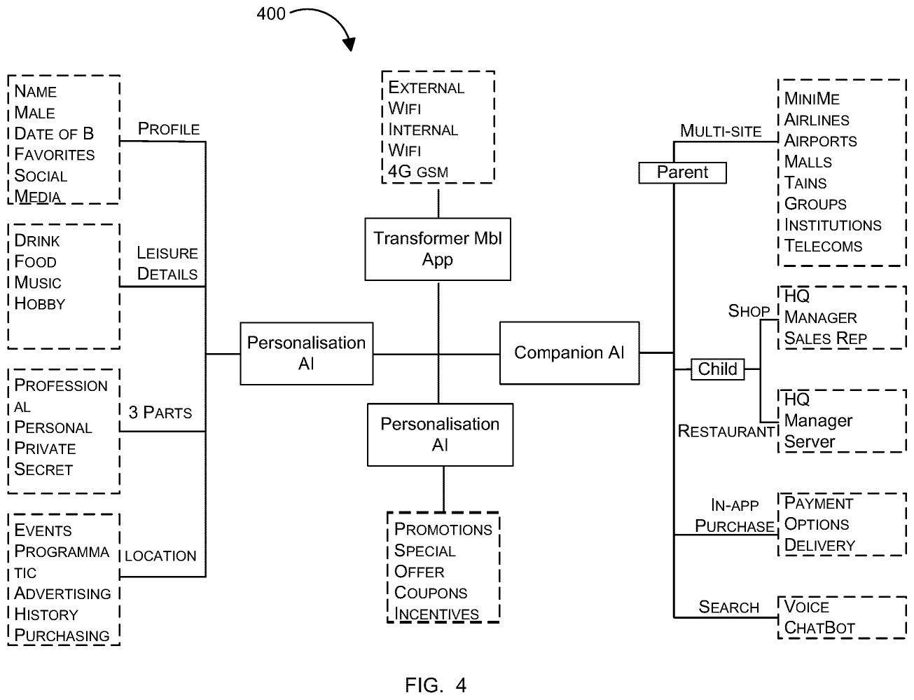

FIG. 4 illustrates a knowledge graph 400 associated with the user profile, in accordance with an embodiment of the present disclosure. In an embodiment of the present disclosure, the created user profile may be stored as the knowledge graph 400 having a plurality of nodes with relations based on the questionnaires 310 and the corresponding response from the user. Such knowledge graph 400 may facilitate the structuring of the user's personal data in a way to make it searchable to fetch a specific piece of the user's personal information. In some embodiments, the knowledge graph may be protected via one or more digital protection technologies, such as encryption and password. As illustrated, the knowledge graph 400 may include, without any limitation, basic details of the user (e.g., name and age), leisure details (e.g., preference for drinks, food, and music), locations, special offers available, coupons available, or the like. It may be noted that similar to the user profile, the knowledge graph 400 may also be stored in the personal memory space of the user and may not be shared with any entity, as described in previous paragraphs.

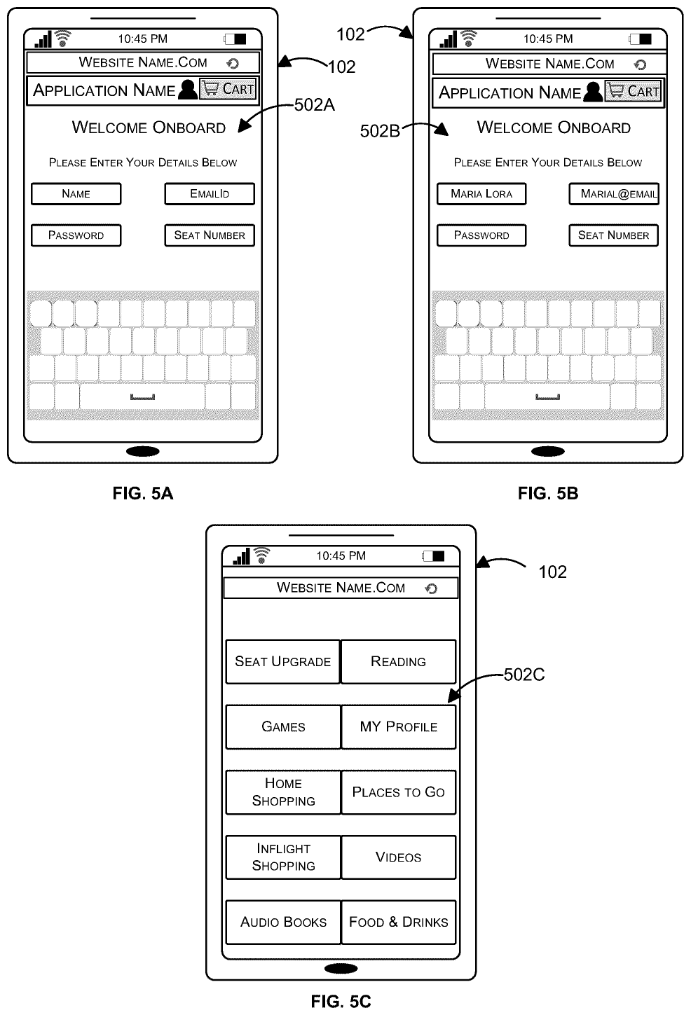

FIGS. 5A-5C illustrate exemplary user device interfaces when the user is connected to an airport departure Wireless-Fidelity (Wi-Fi) network, in accordance with an embodiment of the present disclosure. For the sake of brevity of explanation, FIGS. 5A-5C have been explained together.

In an embodiment of the present disclosure, when the user attempts to connect with the Wi-Fi network of the airport departure, then the system 106 may render a user device interface 502A to answer personalized questions, such as name, email ID, password, and seat number, as shown in FIG. 5A. The user may provide answers to the provided personalized questions, as shown in 502B, as shown in FIG. 5B. Based on the user's answers and location data associated with the Wi-Fi network (i.e., Airport departure), the system 106 associated with the airport may create one or more personalized features for the user associated with seat details, entertainment, nearby places, food menu, or the like. In some embodiments, the system 106 may generate one or more links to one or more web pages for providing the services associated with the one or more personalized features. Upon generating the one or more links, the system 106 may integrate the one or more links to form a personalized digital interface 502C that may be presented automatically on the personalized digital interface associated with the user device 102, as shown in FIG. 5C. As illustrated, the personalized digital interface 502C may include one or more options associated with seat upgrades, reading, games, user profiles, home shopping, places to go, inflight shopping, videos, audiobooks, and/or food and drinks.

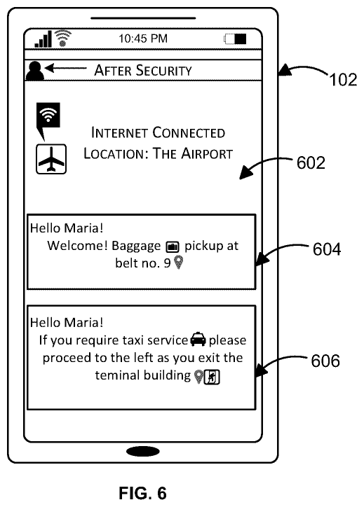

FIG. 6 illustrates an exemplary user device interface when the user is connected to an airport arrival Wi-Fi network, in accordance with an embodiment of the present disclosure. In an embodiment of the present disclosure, when the user reaches the destination, then the user may attempt to connect with the Wi-Fi network of the airport arrival. In such a scenario, the system 106 associated with the airport may create one or more personalized features for the user based on the previously provided user's answers and location data associated with the Wi-Fi network (i.e. Airport arrival). The personalized features may be associated with baggage collection details for the user and cab services for the user. In some embodiments, the system 106 may generate one or more links to one or more web pages for providing the services associated with the one or more personalized features. Upon generating the one or more links, the system 106 may integrate the one or more links to form a personalized digital interface 602 that may be presented automatically on the personalized digital interface associated with the user device 102. As illustrated, the personalized digital interface 602 may include belt details to pick up the baggage and navigation for getting taxi services from the present location.

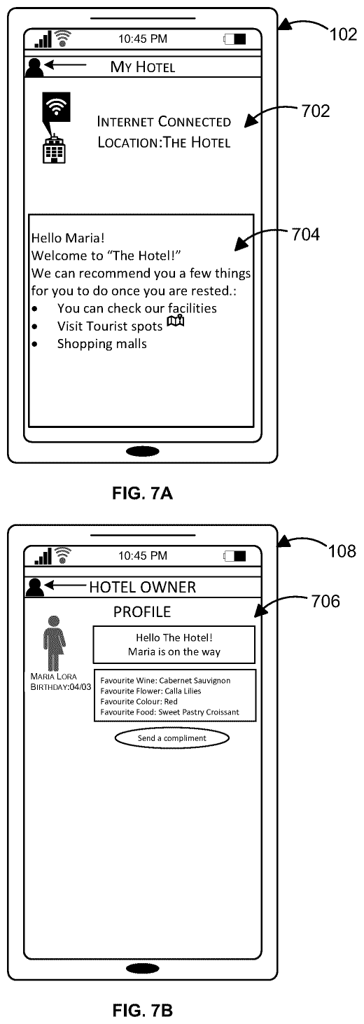

FIG. 7A illustrates an exemplary user device interface when the user is connected to a hotel network, in accordance with an embodiment of the present disclosure. FIG. 7B illustrates an exemplary merchant device interface when the user is connected to a hotel network, in accordance with an embodiment of the present disclosure. For the sake of brevity of explanation, FIGS. 7A and 7B have been explained together.

In an embodiment of the present disclosure, when the user arrives at a hotel, then the user may attempt to connect with the hotel network. In such a scenario, a user device interface 702 may be presented on the personalized digital interface of the user device 102, as shown in FIG. 7A. The user device interface 702 may be formed based on the user account to present a generalized information that is personalized with the username, as shown by 704. Such generalized information may, without any limitation, include an option to check the hotel facilities, an option to visit tourist spots, and an option to check nearby shopping malls. In some embodiments, the system 106 may send the prompt to the user device to answer personalized questions, such as favorite wine, favorite flowers, favorite color, and favorite food. The user may provide answers to the provided personalized questions that may be provided to the establishment via the merchant device 108 (e.g., a device associated with a hotel manager), as shown via a merchant device interface 706 in FIG. 7B. In some embodiments, the establishment may utilize the information in the provided answers to provide personalized service to the user, such as offering the user's favorite wine, using the user's favorite flowers for decoration, using bedsheets of the user's favorite color, and/or prepare user's favorite food.

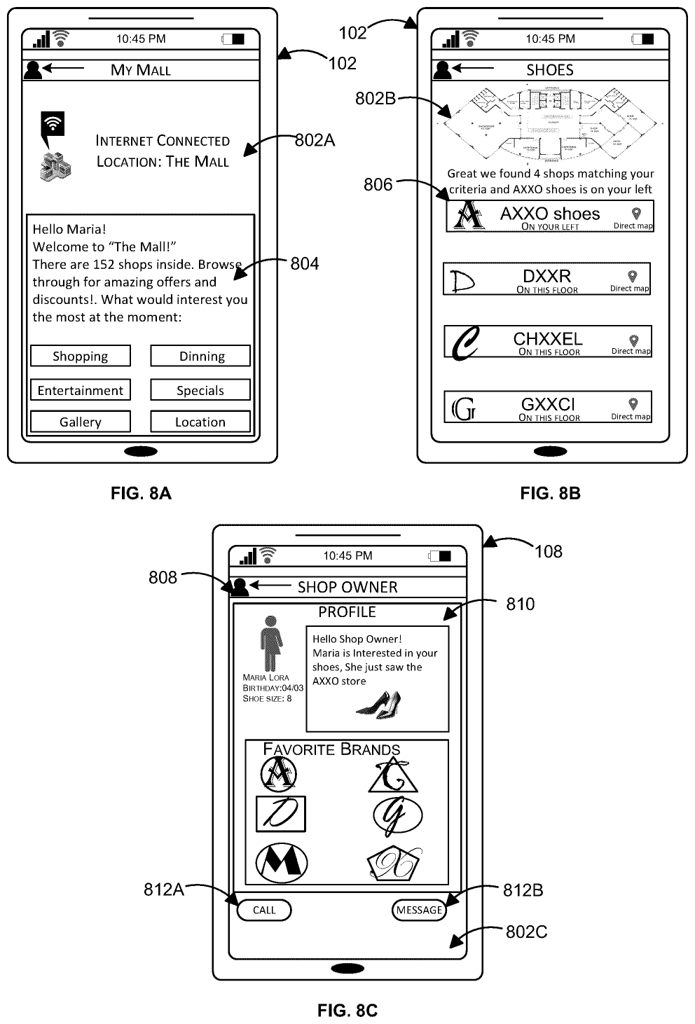

FIGS. 8A-8B illustrates exemplary user device interfaces when the user is connected to a mall network, in accordance with an embodiment of the present disclosure. FIG. 8C illustrates an example illustrates exemplary merchant device interfaces when the user is connected to the mall network, in accordance with an embodiment of the present disclosure. For the sake of brevity of explanation, FIGS. 8A-8C have been explained together.

In an embodiment of the present disclosure, when the user arrives at a mall, then the user may attempt to connect with the mall network. In such a scenario, a first user device interface 802A may be presented on the personalized digital interface of the user device 102, as shown in FIG. 8A. The first user device interface 802A may be formed based on the user account to present a generalized information that is personalized with the username, as shown by 804. Such generalized information may, without any limitation, include a total number of shops in the mall, an option for shopping, an option for dining, an option for entertainment, an option for special activities in the mall, an option to view the gallery, and an option to view location. In some embodiments, the system 106 associated with the mall may send the prompt to the user device 102 to answer personalized questions, such as what the user may be shopping for, the user's preferred brands, and the user's preferred style.

Based on the answers provided by the user and the shops in the mall, the system 106 associated with the mall may create one or more personalized features for the user. The personalized features may be associated with one or more items that the user may be shopping for, the user's preferred brand, and the user's preferred style. In some embodiments, the system 106 may generate one or more links to one or more web pages for showing one or more shops of interest to the user based on the one or more personalized features. Upon generating the one or more links, the system 106 may integrate the one or more links to form a personalized digital interface 802B that may be presented automatically on the personalized digital interface associated with the user device 102, as shown in FIG. 8B. As illustrated, the personalized digital interface 802B may present the user with personalized information 806 including one or more shops that the user may be interested in along with their corresponding navigations.

In some embodiments, the answers provided by the user to the provided personalized questions may be provided to the merchant 808 (e.g., a local shop owner) on the merchant device 108, as shown via a merchant device interface 802C in FIG. 8C. In some embodiments, the merchant device interface 802C may display the user information 810 based on the provided answers, such as the one or more items that the user may be interested in buying along with the preferred brands of the user. In some embodiments, the merchant device interface 802C displays an option 812A to call the user and an option 812B to message the user. As a result, the merchant 808 may be able to target potential customers with their preferences to provide personalized offers and services.

In some embodiments, when the user comes within the pre-defined range of one or more network devices 104 of the one or more shops in the mall, then such one or more network devices 104 may send an automatic prompt to the user. Such automatic prompt may be associated with seeking the user's permission to show one or more products associated with the corresponding shops. Further, such automatic prompt may be associated with requesting the user to answer the personalized question and/or share the user profile to present a personalized interface with personalized services and offers. In some embodiments, the user may enable a pre-defined geofence to enable all shop owners to provide their offers to the user. In such a scenario, the system 106 associated with the mall may collaborate all the offers from all the shop owners to present the user with the best offers to the user for buying the product that the user may be interested in.

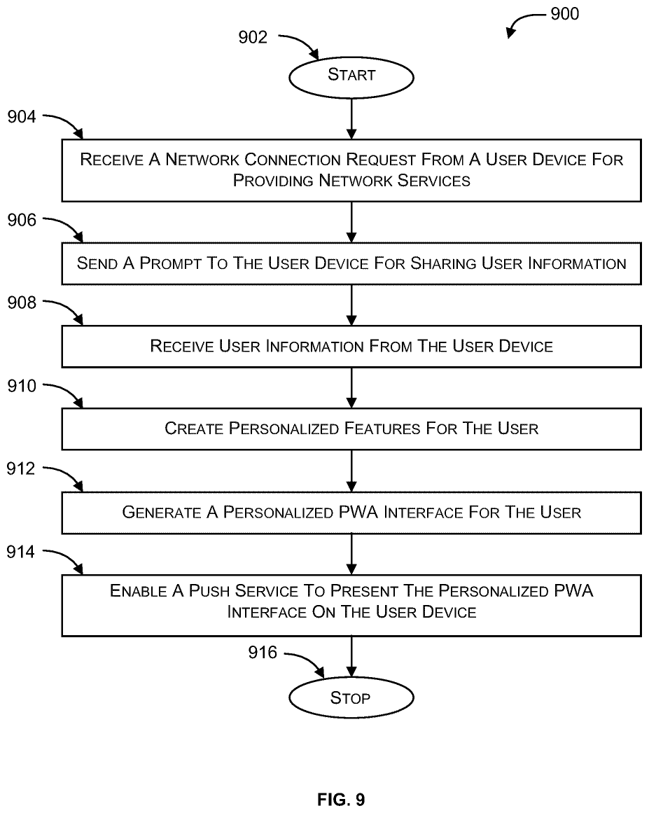

FIG. 9 illustrates a flowchart 900 of a method to provide integrated and personalized services on the personalized digital interface, in accordance with an embodiment of the present disclosure. The method starts at step 902.

At first, a network connection request is received from a user device for providing network services, at step 904. The network connection request may be received through a networking device associated with an establishment. The user device may include, without any limitation, a mobile phone, a laptop, a tablet, a Personal Digital Assistant (PDA), eyeglasses, a smartwatch, a Virtual Reality (VR) device, an Augmented Reality (AR) device, and a Mixed Reality (MR) device. Further, the network services may be associated with a Wireless Fidelity (Wi-Fi), a mobile network, a Local Area Network, an Internet, an Intranet, or a combination thereof. Furthermore, the networking device may be associated with an establishment including a home, a bank, a shop, an office, a restaurant, a theater, a hospital, a hotel, a monument, a street, a sports stadium, an airport, and/or a flight.

In furtherance to receiving the network connection request, a prompt may be sent to the user device for sharing user information, at step 906. The prompt may be associated with the selection of an option to share answers to personalized questions, an option to share a user profile that is stored in a private memory space of a user, or both. In some embodiments, the user profile may be created and maintained based on data fed by the user and user activity data collected from the user device. Further, the user profile may be maintained in form of a knowledge graph having one or more nodes based on a set of personalized questions and corresponding user responses. Alternatively, or additionally, the method may include the steps of sending a prompt to the user device when the user device is detected within a pre-defined range from the networking device.

In response to the user selection of the sent prompt, user information may be received from the user device, at step 908. The user information may include answers to the personalized questions, the shared user profile, or a combination thereof. Next, one or more personalized features for the user may be created, at step 910. The one or more personalized features may be associated with one or more services and may be created based on location of the networking device and the received user information, such as information about the user location data, advertisements of entities in proximity, offers, and rewards associated with the proximate entities, payment gateways, menus, events, location alerts, and feedbacks, interactive elements, 3D visual elements, and virtual objects.

At step 912, a personalized digital interface may be generated having links to one or more web pages based on the created one or more personalized digital interfaces on the user device. Thereafter, a push service to present the personalized digital interface on the user device may be enabled, at step 914.

In some embodiments of the present disclosure, the method may include the steps of providing the user information to an establishment associated with the networking device (e.g., merchant device), such that the establishment may provide personalized offers and services to the user. The personalized services may, without any limitation, include a food menu based on user preferences, apparels based on user's size, a room with a user preference temperature, and products based on the user profile. The method ends at step 916.

In an embodiment of the present disclosure, the system and method to provide integrated and personalized service on the personalized digital interface disclosed in the present disclosure (for the sake of brevity, hereinafter termed as ‘disclosed mechanism’) do not require downloading or installing of an application on the user device. Thus, the disclosed mechanism that utilizes the personalized digital interface saves data, saves storage space on the user device, and eliminates the need to update the application. Since the disclosed mechanism automatically opens the personalized digital interface on the user device when the user device connects to a network device, the disclosed mechanism provides ease of use to the user. Also, since the disclosed mechanism displays a user-centric personalized interface on the personalized digital interface based on the user information based and the location data, the disclosed mechanism is very convenient to the user. Additionally, since the disclosed mechanism facilitates the user to store the user profile in the personal memory space rather than the server, the disclosed mechanism provides the user with complete control over personal data and reduces the risk of data theft or leakage.

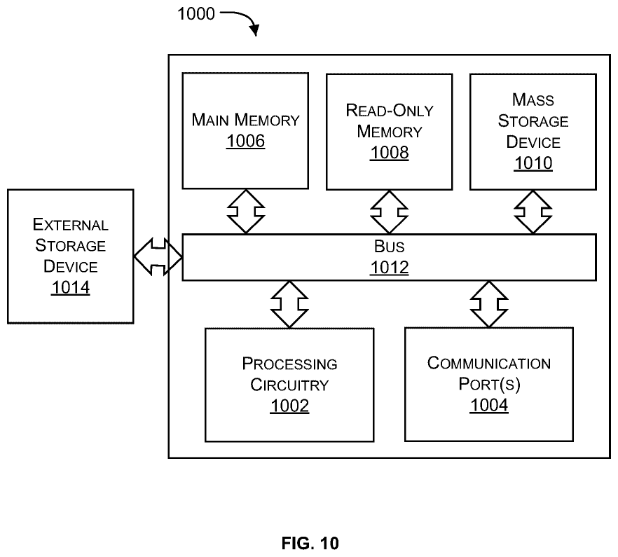

FIG. 10 illustrates an exemplary computer system in which or with which embodiment of the present disclosure may be utilized. As shown in FIG. 10, a computer system includes an external storage device 1002, a bus 1004, a main memory 1006, a read-only memory 1008, a mass storage device 1010, a communication port 1012, and a processor 1014.

Those skilled in the art will appreciate that computer system 1000 may include more than one processor 1014 and communication ports 1012. Examples of processor 1014 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 1014 may include various modules associated with embodiments of the present disclosure.

Communication port 1012 can be any of an RS-232 port for use with a modem-based dialup connection, a 10/100 Ethernet port, a Gigabit or 10 Gigabit port using copper or fiber, a serial port, a parallel port, or other existing or future ports. Communication port 1012 may be chosen depending on a network, such as a Local Area Network (LAN), Wide Area Network (WAN), or any network to which the computer system connects.

Memory 1006 can be Random Access Memory (RAM), or any other dynamic storage device commonly known in the art. Read-Only Memory 1008 can be any static storage device(s) e.g., but not limited to, a Programmable Read-Only Memory (PROM) chips for storing static information e.g., start-up or BIOS instructions for processor 1014.

Mass storage 1010 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 1004 communicatively couples processor(s) 1014 with the other memory, storage, and communication blocks. Bus 1104 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 1014 to a software system.

Optionally, operator and administrative interfaces, e.g., a display, keyboard, and a cursor control device, may also be coupled to bus 1004 to support direct operator interaction with the computer system. Other operator and administrative interfaces can be provided through network connections connected through communication port 1012. An external storage device 1002 can be any kind of external hard-drives, floppy drives, IOMEGA® Zip Drives, Compact Disc—Read-Only Memory (CD-ROM), Compact Disc—Re-Writable (CD-RW), Digital Video Disk—Read Only Memory (DVD-ROM). The components described above are meant only to exemplify various possibilities. In no way should the aforementioned exemplary computer system limit the scope of the present disclosure.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the disclosure, other and further embodiments of the disclosure may be devised without departing from the basic scope thereof. The scope of the disclosure is determined by the claims that follow. The disclosure is not limited to the described embodiments, versions, or examples, which are included to enable a person having ordinary skill in the art to make and use the disclosure when combined with information and knowledge available to the person having ordinary skill in the art.

We claim:

1. A system to provide integrated and personalized services personalized digital interface the system comprising:
one or more Network Service Provider (NSP) modules to receive a network connection request, through a networking device, from a user device for providing network services;
a data collection module to:
send, in furtherance to receiving the network connection request, a prompt to the user device to select at least one of: answer personalized questions and share a user profile that is stored in a private memory space of a user;
receive, in response to user selection of the sent prompt, user information including at least one of: answers to the personalized questions and the shared user profile;
an Artificial Intelligence (AI) module to create one or more personalized features, associated with one or more services, for the user based on location of the networking device and the received user information;
an integrating module to generate a personalized digital interface comprising links to one or more webpages, based on the created one or more personalized features for the user;
a personalized digital interface push module to enable a push service to present the personalized digital interface on the user device.

2. The system of claim 1, wherein the user profile is created and maintained based on data fed by the user and user activity data collected from the user device.

3. The system of claim 1, wherein the user profile is maintained in form of a knowledge graph having one or more nodes based on a set of personalized questions and corresponding user responses.

4. The system of claim 1, wherein the data collection module is triggered to send a prompt to the user device when the one or more NSP modules detect the user device within a pre-defined range from the networking device. The system of claim 1, wherein the user device includes at least one of: a mobile phone, a laptop, a tablet, and a Personal Digital Assistant (PDA), eyeglasses, a smartwatch, a Virtual Reality (VR) device, an Augmented Reality (AR) device, and a Mixed Reality (MR) device.

6. The system of claim 1, wherein the one or more NSP modules are associated with at least one of: a Wireless Fidelity (Wi-Fi), a mobile network, a Local Area Network, an Internet, and an Intranet.

7. The system of claim 1, wherein the networking device is associated with an establishment including at least one of: a home, a bank, a shop, an office, a restaurant, a theater, a hospital, a hotel, a monument, a street, a sports stadium, an airport, and a flight.

8. The system of claim 1, wherein the one or more personalized features are associated with at least one of: information about the user location data, advertisements of entities in proximity, offers and rewards associated with the proximate entities, payment gateways, menus, events, location alerts, and feedbacks, interactive elements, 3D visual elements, and virtual objects.

9. The system of claim 1, wherein the data collection module further provides the user information to a merchant device, such that a merchant provides personalized offers and services to the user.

10. The system of claim 9, wherein the personalized services include at least one of: a food menu based on user preferences, apparel based on user's size, a room with a user preference temperature, and products based on user profile.

11. A method to provide integrated and personalized services on a personalized digital interface, the method comprising:
receiving a network connection request, through a networking device, from a user device for providing network services;
sending, in furtherance to receiving the network connection request, a prompt to the user device to select at least one of: answer personalized questions and share a user profile that is stored in a private memory space of a user;
receiving, in response to user selection of the sent prompt, user information including at least one of: answers to the personalized questions and the shared user profile;
creating one or more personalized features, associated with one or more services, for the user based on location of the networking device and the received user information;
generating a personalized digital interface comprising links to one or more webpages, based on the created one or more personalized features for the user;
enabling a push service to present the personalized digital interface on the user device.

12. The method of claim 11, wherein the user profile is created and maintained based on data fed by the user and user activity data collected from the user device.

13. The method of claim 11, wherein the user profile is maintained in form of a knowledge graph having one or more nodes based on a set of personalized questions and corresponding user responses.

14. The method of claim 11, further comprises sending a prompt to the user device when the user device is detected within a pre-defined range from the networking device. The method of claim 11, wherein the user device includes at least one of: a mobile phone, a laptop, a tablet, and a Personal Digital Assistant (PDA).

16. The method of claim 11, wherein the network services are associated with at least one of: a Wireless Fidelity (Wi-Fi), a mobile network, a Local Area Network, an Internet, an Intranet, eyeglasses, a smartwatch, a Virtual Reality (VR) device, an Augmented Reality (AR) device, and a Mixed Reality (MR) device.

17. The method of claim 11, wherein the networking device is associated with an establishment including at least one of: a home, a bank, a shop, an office, a restaurant, a theater, a hospital, a hotel, a monument, a street, a sports stadium, an airport, and a flight.

18. The method of claim 11, wherein the one or more personalized features are associated with at least one of: information about the user location data, advertisements of entities in proximity, offers and rewards associated with the proximate entities, payment gateways, menus, events, location alerts, and feedbacks, interactive elements, 3D visual elements, and virtual objects.

19. The method of claim 11, further comprises providing the user information to a merchant device, such that a merchant provides personalized offers and services to the user.

20. The method of claim 19, wherein the personalized services include at least one of: a food menu based on user preferences, apparels based on user's size, a room with a user preference temperature, and products based on user profile.
